(19) United States
(12) Patent Application Publication
(10) Pub. No.: US 2012/0044056 A1
(43) Pub. Date: Feb. 23, 2012

(54) ELECTRONIC SHELF LABEL SYSTEM AND COMMUNICATING METHOD USING THE SAME

(76) Inventors: Gi Young Byun, Incheon (KR); Chang Soo Lim, Seoul (KR); Hak Sun Kim, Daejeon (KR); Song On Lee, Gyeonggi-do (KR); Hyun Hak Kim, Gyeonggi-do (KR)

(21) Appl. No.: 13/212,902

(22) Filed: Aug. 18, 2011

(30) Foreign Application Priority Data
Aug. 18, 2010 (KR) 10-2010-0079826

(51) Int. Cl. G06K 7/01

(52) U.S. Cl. 340/10.1

(57) ABSTRACT

Disclosed herein is an electronic shelf label system. The electronic shelf label system includes a wired/wireless converter wirelessly transmitting product information according to request of a server, at least one rail installed on a product display stand and including a plurality of electrical wirings, at least one first electronic tag installed in the rail and performing wireless communication with the wired/wireless converter, and a plurality of second electronic tags each installed in the rail and performing wired communication with the first electronic tag through the electronic wirings. The electronic shelf label system uses the hybrid communication in which wire and wireless are mixed, thereby making it possible to provide the smooth communication environment by removing a shadow area of communication while dispersing communication traffic.

### CROSS REFERENCE TO RELATED APPLICATION

This application claims the benefit Korean Patent Application No. 10-2010-0079826, filed on Aug. 18, 2010, entitled “Electronic Shelf Label System And Communicating Method Using The Same”, which is hereby incorporated by reference in its entirety into this application.

### BACKGROUND OF THE INVENTION

1. Technical Field

The present invention relates to an electronic shelf label system, and more particularly, to an electronic shelf label system capable of increasing availability of electronic tags using wired/wireless hybrid communications.

2. Description of the Related Art

Generally, a paper label representing information and prices of each product has been mainly used at places where a large number of products are displayed and sold in a predetermined space, such as a distribution store, or the like. However, since it is cumbersome to write the updated information on the paper label one by one each time the product information is updated, and it is difficult to manage the paper label, the paper label is being replaced with an electronic tag.

When the updated information of the products is wirelessly transmitted in a wired/wireless communication converter according to a request of a central server, the electronic tag receives and displays the updated information. Therefore, the electronic tags for all the products can be controlled by the central server, such that they can be managed efficiently.

Meanwhile, in the case of the large-scale distribution store that sells various products, the electronic tags corresponding to the number of products should be installed, the wireless communication traffic of the wired/wireless converter transmitting product information to the electronic tags is increased. This is a factor that may cause the communication failure, such that it is required to efficiently operate wireless resources. Further, the distribution store may have the unexpected shadow area of a radio wave since the concentration of products is high and a product display stand is made of an iron material having disadvantages in radio wave communication. Therefore, it is difficult to smoothly transmit information due to the wireless communication between wired/wireless converter and the electronic tags.

### SUMMARY OF THE INVENTION

An object of the present invention is to provide a unit capable of reducing or dispersing communication traffic by using a hybrid scheme in which wired/wireless communications are mixed and reducing a shadow area of communication.

Further, an object of the present invention is to provide a unit capable of promoting products while maximally suppressing additional cost of electronic tags.

According to an exemplary embodiment of the present invention, there is provided an electronic shelf label system, including: a wired/wireless converter wirelessly transmitting product information according to a request of a server; at least one rail installed on a product display stand and including a plurality of electrical wirings; at least one first electronic tag installed in the rail and performing wireless communication with the wired/wireless converter; and a plurality of second electronic tags each installed in the rail and performing wired communication with the first electronic tag through the electronic wirings.

According to an exemplary embodiment of the present invention, there is provided a communicating method using an electronic shelf label system including a wired/wireless converter wirelessly transmitting product information according to a request of a server, at least one first electronic tag performing wireless communication with the wired/wireless converter, and a plurality of second tags performing wired communication with the first electronic tag, the communicating method including: (a) collecting and storing IDs of the second electronic tags by the first electronic tag; (b) searching the first electronic tags or the second electronic tags of specific IDs corresponding to product information received from the wired/wireless converter to request update of the product information; and (c) transmitting a request performance response signal informing performance ending after the product information is updated.

According to an exemplary embodiment of the present invention, there is provided an electronic shelf label system, including: wired/wireless converter wirelessly transmitting information according to a request of a server; at least one rail installed on a product display stand; at least one first electronic tag installed in the rail and performing wireless communication with the wired/wireless converter; a plurality of second tags each installed in the rail and performing wired communication with the first electronic tag; and at least one third electronic tag installed on the product display stand and performing wired communication with the first electronic tag.

### BRIEF DESCRIPTION OF THE DRAWINGS

FIG. 1 is a diagram showing a configuration of an electronic shelf label system according to a first exemplary embodiment of the present invention;

FIG. 2 is an enlarged view of a rail of FIG. 1;

FIG. 3 is an enlarged view of a flexible printed circuit board of FIG. 2;

FIG. 4 is a diagram showing an example of the connection relation between the rail of FIG. 1 and the flexible printed circuit board;

FIG. 5 is a diagram showing a topology type between a wired/wireless convertor and electronic tags according to the exemplary embodiment of the present invention;

FIG. 6 is a message sequence chart for an operational algorithm of the topology configuration of FIG. 5;

FIG. 7 is a diagram showing a configuration of an electronic shelf label system according to a second exemplary embodiment of the present invention; and

FIG. 8 is a block diagram showing an example of the inner configuration of an electronic tag and a promotional electronic tag and the connection relationship therebetween.

### DESCRIPTION OF THE PREFERRED EMBODIMENTS

Hereinafter, exemplary embodiments of the present invention will be described with reference to the accompanying drawings. However, the invention may be embedded in many different forms and should not be construed as limited to the embodiments set forth herein.

In the following description, when it is determined that the detailed description of the conventional technology related to the present invention would confuse the gist of the present invention, such a description may be omitted. Terms used in the specification and claims herein are defined by considering the functions thereof in the present invention so that they may be varied according to a user's and an operator's intentions or practices. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

Hereinafter, an electronic shelf label system according to exemplary embodiments of the present invention will be described below with reference to the accompanying drawings.

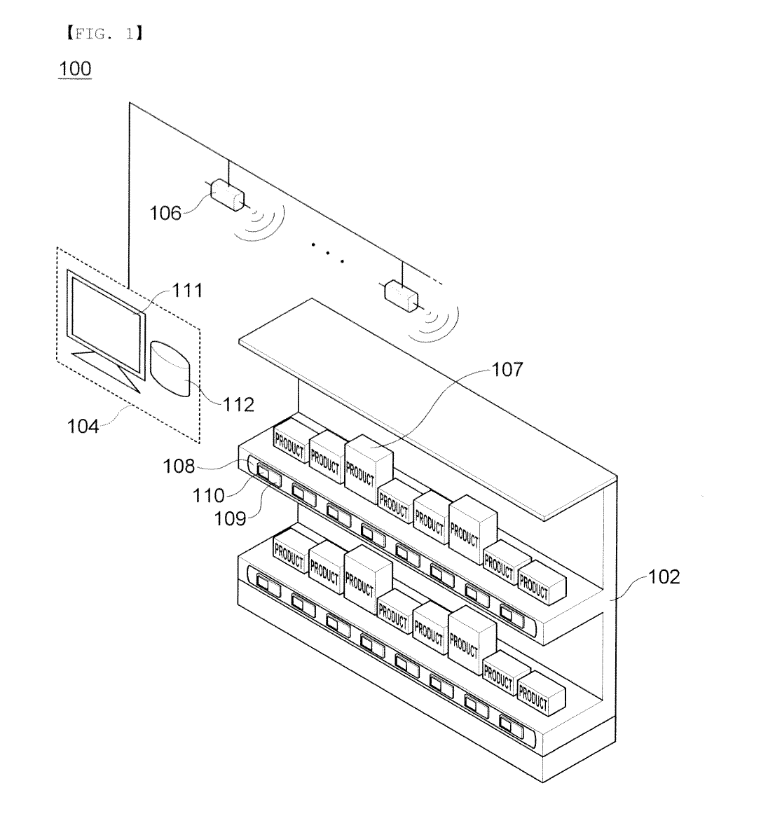

FIG. 1 is a diagram showing a configuration of an electronic shelf label system 100 according to a first exemplary embodiment of the present invention.

The electronic label system 100 according to the first exemplary embodiment of the present invention includes a product display stand 102, a server 104, and a wired/wireless converter 106.

The operation of each block in the electronic shelf label system 100 configured as described above is as follows.

First, a plurality of products 107 are displayed on each of the shelves of the product display stand 102 and a rail 108 is mounted on the front surface of each shelf. The rail 108 is mounted with the plurality of electronic tags 109. The electronic tag 109 includes a display unit 110 that displays basic information of products. In this case, the basic information of products includes price, expiration date, production date of products, or the like. Meanwhile, although not shown in the drawings, the rail 108 is mounted with electrical wirings electrically connecting the electronic tags 109. Therefore, it is possible to perform wired communication between the electronic tags 109 sharing the same rail 108.

Meanwhile, the server 104 includes an information processor 111 and a database unit 112.

The information processor 111 receives updated product information from a manager, stores it in the database 112, and transmits the updated product information to the wired/wireless converter 106 by wire. In addition, the product information transmitted from the electronic tag 109 received through the wired/wireless converter 106 and is stored in the database unit 112. In this case, the information processor 111 may be configured in computer.

The wired/wireless converter 106 receives the product information from the server 104 by wire and wirelessly transmits it to the electronic tags 109 of the product display stand 102. In addition, the electronic tags 109 receive information wirelessly transmitted and transmit it to the server 104 by wire. As such, the wired/wireless converter 106 performs wired communication with the server and performs wireless communication with the electronic tags 109. That is, the wired/wireless converter 106 exchanges information between the server 104 and the electronic tags 109 by the wired/wireless communication.

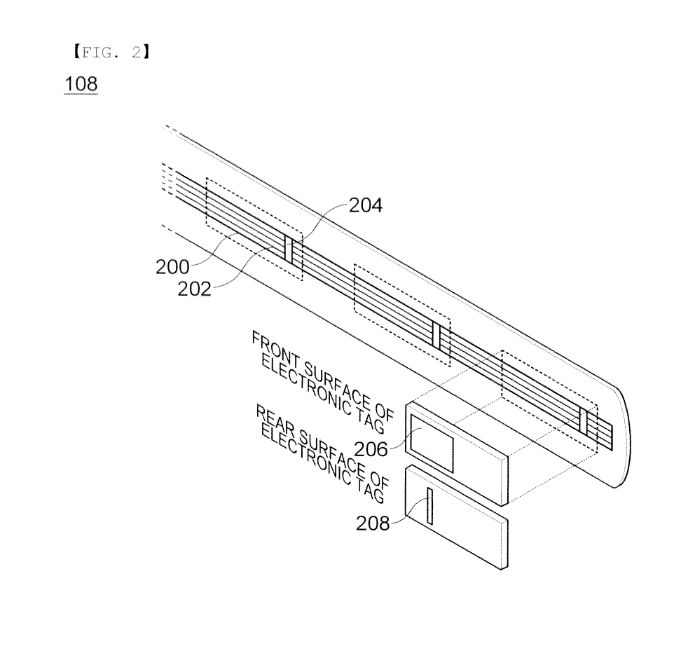

FIG. 2 is an enlarged view of a rail of FIG. 1.

Referring to FIG. 2, the rail 108 is mounted with a flexible printed circuit board (PCB) 200 on which electrical wirings 202 are disposed. The electrical wirings 202 are mounted with a connector 204 at predetermined interval. Meanwhile, the electronic tags are attached to the rail 108 at a predetermined interval and the rear surface of the electronic tags are each provided with connector 208 to contact the connector 204 mounted in the electrical wirings 202, such that the electrical tags are electrically connected to the electrical wirings 202. In this case, the electrical wirings 202 may be configured to include electrical wirings for communication to transmit the information between electronic tags and electrical wirings for a power supply to supply power to the electronic tags.

The electronic tags wirelessly receive the updated product information from the wired/wireless converter. In this case, in the exemplary embodiment of the present invention, one or a portion of the electronic tags sharing one rail is configured as a representative electronic tag performing the wireless communication with the wired/wireless converter The remaining electronic tags receive information received by the representative electronic tag through the electrical wirings for communication by wire, without participating in the wireless communication with the wired/wireless converter. That is, all the electronic tags sharing one rail do not perform the direct wireless communication with the wired/wireless converter, but only the representative electronic tag performs the wireless communication with the wired/wireless converter. The remaining electronic tags perform the wired communication with the representative electronic tags. Therefore, only the representative electronic tags performing the direct wireless communication with the wired/wireless converter includes an RF modem and processing circuits therefor and the remaining electronic tags receiving information from the representative electronic tag do not need to include the RF modem and the processing circuits therefor, thereby making it possible to simplify the configuration. For example, if the number of electronic tags mounted on one rail is N and only one of them is configured as the representative electronic tags, the costs can be saved corresponding to N−1.

As described, only a portion of the electronic tags installed in the rail participates in the wireless communication, thereby making it possible to simplify the configuration of most of the electronic tags and only a portion of the electronic tags performs the wireless communication with the wired/wireless converter, thereby making it possible to largely reduce the wireless communication traffic.

Meanwhile, in order to communicate the electronic tags in a wired/wireless scheme and display the product information, a predetermined power supply is required. In general, a method of mounting a battery in the electronic tag has been mainly used. However, as the number of products displayed on the product display stand is increased and the number of electronic tags is increased correspondingly, battery costs are increased correspondingly. In addition, even when the same capacity of battery is mounted in each of the electronic tags, the lifespan of each battery is different by several variables and if a predetermined time elapses after installation, much time and additional costs are consumed to search the discharged battery one by one and replace it. In the present invention, since power is commonly supplied to the plurality of electronic tags through electrical wirings for a power supply installed in the rail, maintenance is facilitated and battery costs may be reduced. In this case, a power facility may be provided on the product splay stand or a separate power facility may be provided.

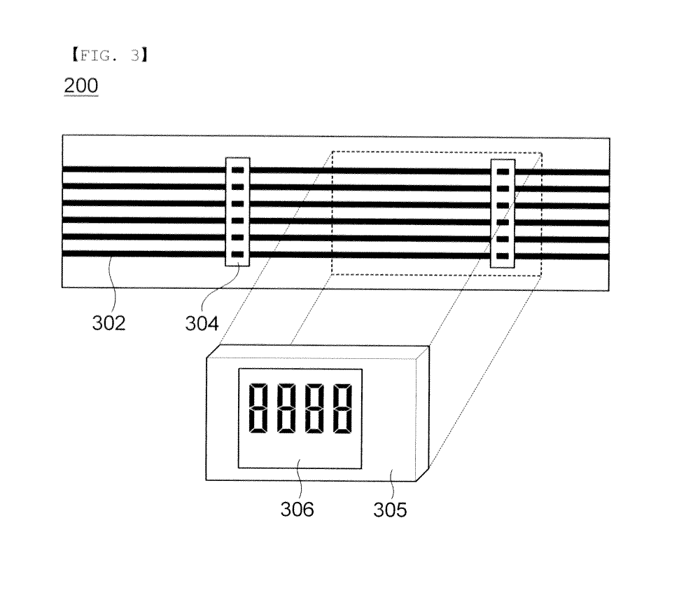

FIG. 3 is an enlarged view of the flexible printed circuit board of FIG. 2.

Referring to FIG. 3, a plurality of electrical wirings 302 are disposed on the flexible printed circuit board 200 and a connector 304 is installed at a predetermined interval. As shown in FIG. 2, the connector 304 installed in the electrical wirings 302 contacts the connector installed on the rear surface of the electronic tag 305, such that the electronic tag 305 is electrically connected to the electric wirings 302. Therefore, the representative electronic tag and the electronic tag 305 share the electrical wirings 302, thereby making it possible to perform the wired communication.

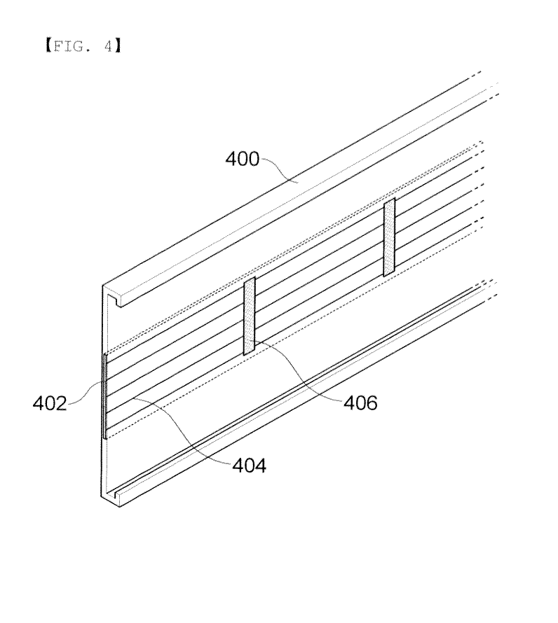

FIG. 4 is a diagram showing an example of a connection relationship between the rail of FIG. 1 and the flexible printed circuit board.

Referring to FIG. 4, as one of the methods of installing a flexible printed circuit board 402 in a rail 400, there is a method of inserting and fixing the flexible printed circuit board 402 in the rail 400 and exposing a connector 406 to the outside of the rail 400. In this case, it is possible to install the flexible printed circuit board 402 at the outside of the rail 400. As described above, the electronic tag is electrically connected to the electrical wirings 404 through the connector 406 by mounting the electronic tags in the rail 400 from which the connector 406 is exposed to the outside.

FIG. is a diagram showing topology type between the wired/wireless converter and the electronic tags according to the exemplary embodiment of the present invention.

As described above, since the representative electronic tags of the entire electronic tags according to the exemplary embodiment of the present invention performs the wireless communication with the wired/wireless converter, they should have the RF modem necessary for wireless communication and the processing circuits therefor, which is called a full function device (FFD). Meanwhile, the remaining electronic tags receiving the information from the representative electronic tags by wire do not need to have the RF modem and the processing circuits therefor, thereby simplifying the configuration, which is called a reduced function device (RFD).

A wired/wireless converter 500 and FFDs 510 have a star topology type and the wireless communication is performed between the wired/wireless converter 500 and the FFD 510. Meanwhile, each of the FFDs 510 and the RFDs 520 also have a star topology type and the wired communication is performed between the FFD 510 and the RFD 520. If all the electronic tags perform the direct wireless communication with the wired/wireless converter 500, all the electronic tags become the FFD 510. Therefore, since the number of FFDs 510 charged by one wired/wireless converter 500 is increased, the wireless communication traffic is rapidly increased, thereby causing the communication failure.

However, according to the exemplary embodiment of the present invention, since an information exchanging step is divided into two steps, that is, an information exchanging step through the wireless communication between the wired/wireless converter 500 and the FFP 510 and the information exchanging step through the wired communication between the FFD 510 and the RFD 520, the communication traffic is dispersed into wireless communication and wired communication, thereby making it possible to prevent the increase in communication traffic to any one of the wireless or wired communication.

Meanwhile, since the FFD 510 simultaneously performs the role as the electronic tag and the role of relaying the wireless communication, the load in performing the roles may be increased. Further, since the ratio of the FFD 510 among all the electronic tags is very low, the FFD 510 may be manufactured to perform only the relaying role, while removing the display function. Alternatively, the FFD 510 only serving to relay between the wired/wireless converter 500 and the RFD 520 may be provided separately.

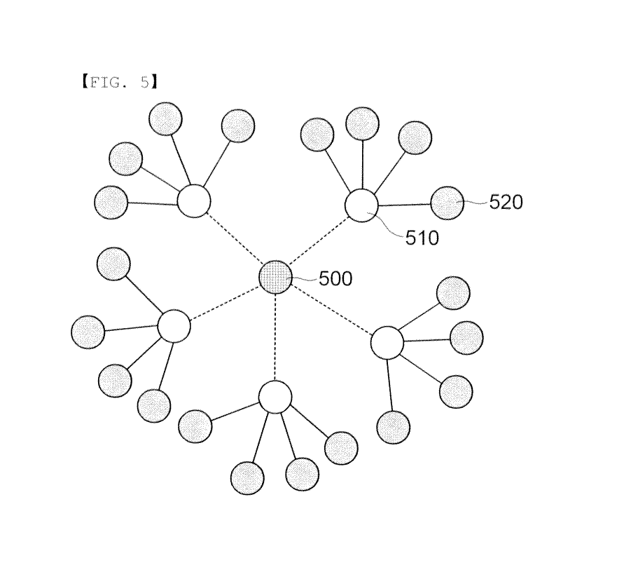

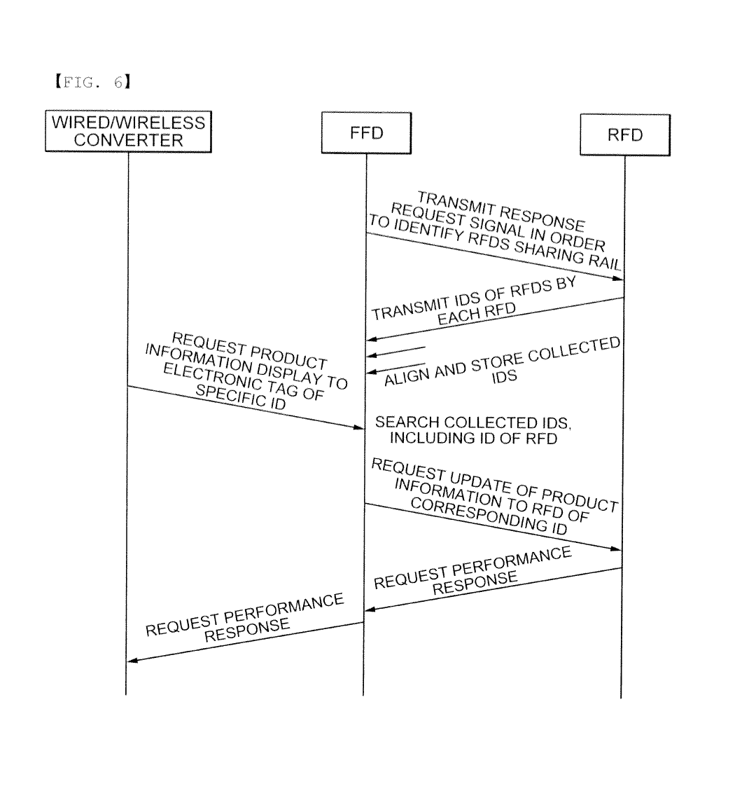

FIG. 6 is a message sequence chart for an operational algorithm of the topology configuration of FIG. 5.

Referring to FIG. 6, the FFD transmits the response requesting signals through the electrical wirings in order to identify the RFDs sharing the same rail. Therefore, the RFDs each transmits its own ID and the FFD collects, aligns, and stores the IDs received from the RFDs.

Thereafter, if the wired/wireless converter receives the request of the server and transmits the request of the product information display o the electronic tags having specific IDS, the FFD searches the requested ID among the collected IDs, including the ID of the FFD. The RFD of the corresponding ID receives the request of the product information update and the requested RFD receives and stores the update information and displays it through a display unit. In addition, the request performance response signals are transmitted to the FFD in order to inform that the FFD performs the received request. Thereby, the FFD transmits the request performance response signals to the wired/wireless converter in order for the corresponding RFD to receive the updated information and inform that the updated information is being displayed.

As described above, unlike performing the information exchange between the wired/wireless converter and the electronic tags only by the wireless communication, the electronic shelf label system according to the first exemplary embodiment of the F resent invention performs the information exchange between the wired/wireless converter and the electronic tags by using the hybrid communication in the wire and wireless are mixed, thereby dispersing the communication traffic into wire and wireless and covering the shadow area existing at the time of the wireless communication by wire. In addition, only a portion of the electronic tags performs the wireless communication with the wired/wireless converter, thereby making it possible to simplify the configuration of most of the electronic tags and saving the hardware costs.

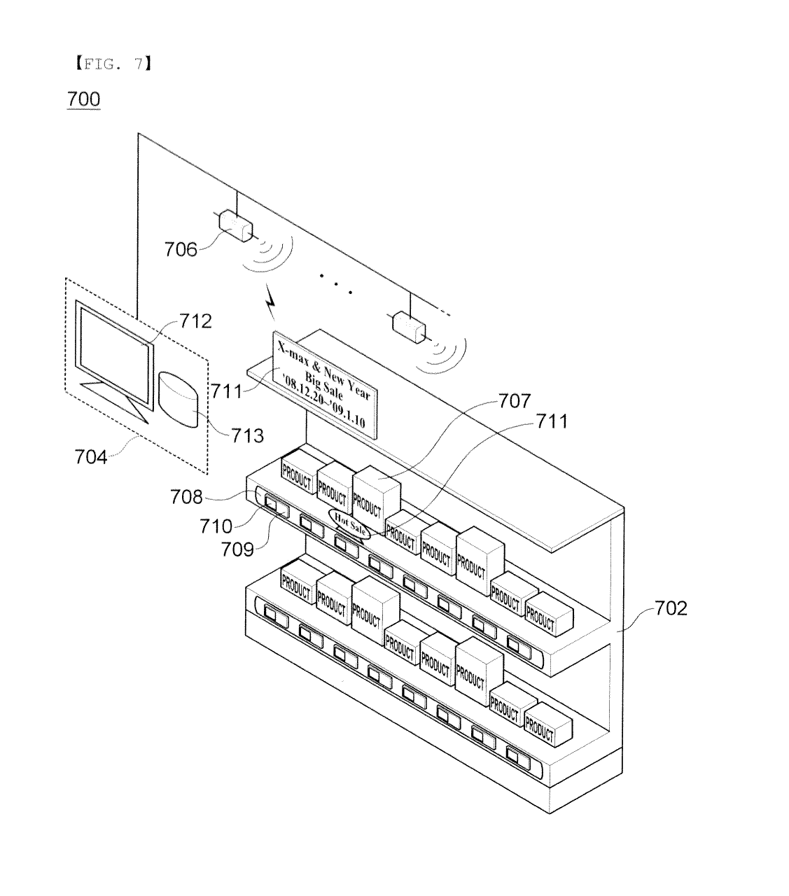

FIG. 7 is a block diagram showing a configuration of an electronic shelf label system 700 according to a second exemplary embodiment of the present invention.

An electronic shelf label system 700 according to a second exemplary embodiment of the present invention includes a product display stand 702, a server 704, and a wired/wireless converter 706, as shown in FIG. 7.

Functions of each block of the electronic shelf label system 700 constituted as described above will be described below.

First, each of the shelves of the product display stand 702 display a plurality of products 707, wherein the fronts of each shelf are installed with rails 708. The rails 708 are basically installations for installing electronic tags 709 to visually display product information. The electronic tag 709 includes a display unit 710 for displaying product information. An example the basic information of products provided through the display unit 710 may include the price, expiration date, production date of products, etc. Meanwhile, although not shown in the drawings, the rail 708 is disposed with the electrical wirings for electrically connecting the electronic tags 709. Therefore, the wire communication can be performed between the electronic tags 709 sharing the same rail 708. In this case, power may collectively be supplied to the electronic tags 709 by configuring a portion of the electrical wirings as the electrical wirings for a power supply In this case, it is advantageous in saving costs since there is no need to mount the battery in each electronic tags 709.

Meanwhile, the server 704 includes an information processor 711 for receiving or processing the product information and a database unit 712 for storing the product information. In this case, the information processor 711 may be configured in a computer.

The wired/wireless converter 706 receives the product information from the server 704 by wire and wirelessly transmits it to the electronic tags 709 of the product display stand 702. To the contrary, the electronic tags 709 receive product information wirelessly transmitted and transmit it to the server 104. As described above, the wired/wireless converter 706 performs the wired communication with the server and performs the wireless communication with the electronic tags 709. That is, the wired/wireless converter 706 exchanges the information between the server 704 and the electronic tags 709 by the wired/wireless communication.

Meanwhile, in order to search the additional utilization of the electronic tag 709 providing only the basic information for the existing products, a promotional electronic tag 711 may be disposed on the upper end of the product display stand 702 or in front of the specific products 707. In this case, the promotional electronic tag 711 displays a promotional information message (PIM) that can arouse the purchasing demand of a consumer by using simple information, such as specific discount price, specific product promoting contents, or “SALE!”, “LOW PRICE”, or the like, in the distribution store. The panel of the promotional electronic tag 711 is manufactured to have a larger area than other electronic tags 709 to be used in the advertisement of the entire store and is manufactured to be smaller than the other electronic tags 709, such that is may be used in promoting the specific products 707.

The panel of the promotional electronic tag 711 may be configured as a display such as an LCD, AMOLED, etc. or may be configured as an electrophoretic display (EPD). The electrophorectic display has advantages in texture, readability, low power driving, bendability due to a thinner thickness than other displays. The electrophorectic display may be applied to the promotional electronic tag 711 as well as all the electronic tags 709.

Meanwhile, the promotional electronic tag 711 may directly receive the promotional message information by performing the direct wireless communication with the wired/wireless converter 706 and display the contents, Further, the electronic tag 711 may receive the promotional message information from the representative electronic tags performing the direct wireless communication with the wired/wireless converter 706 among the electronic tags 709 That is, the promotional electronic tag may be configured as one of the electronic tags 709 participating in the above-mentioned hybrid communication network and may be configured in a type that is subordinated in the electronic tag 709 participating in the hybrid communication network. In this case, in order for the promotional electronic tag 711 to perform the direct wireless communication with the wired/wireless converter 706, the RF modem and the processing circuits therefor should be included in the promotional electronic tag 711. Therefore, indirectly receiving the promotional message information from the representative electronic tag or other electronic tags 709 can simplify the configuration and save costs.

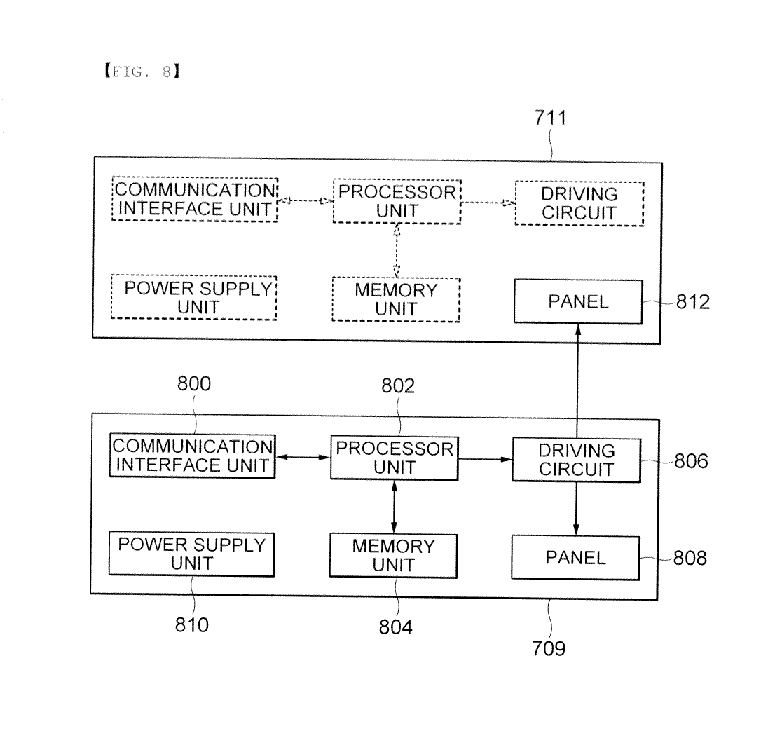

FIG. 8 is a block diagram showing an example of the internal configuration of the electronic tag and the promotional electronic tag and the connection relation therebetween.

Referring to FIG. 8, the electronic tag 709 includes a communication interface unit 800, a processor unit 802, a memory unit 804, a driving circuit 806, a panel 808, and a power supply unit 810. On the other hand, the promotional electronic tag 711 includes a panel 812. In this configuration, the electronic tag 709 indicates the representative electronic tag wirelessly receiving the product information and the promotional message information from the wired/wireless converter 706.

Each block of the electronic tag 709 will be described in more detail.

The communication interface unit 800 performs the wireless communication with the wired/wireless converter 706 to serve to transmit and receive the product information and the promotional message information. The processor unit 802 processes the received product information and the promotional message information and transmits them to the driving circuit 806. The driving circuit 806 drives the panel 808 according to the product information to display the product information through the panel 808 and drives the panel 812 of the promotional electronic tag 711 according to the promotional message information to display the promotional message through the panel 812. Meanwhile, the power supply unit 810 may be included in the electronic tag 709 but may be supplied with power through the electrical wirings for a power supply among the electrical wirings installed in the rail 708.

As described above, when the representative electronic tag is used as a master and the promotional electronic tag 711 is used as a slave, the communication interface unit, the processor unit, the memory unit, the driving circuit, and the power supply unit may be removed from the configuration of the promotional electronic tag 711. That is, the promotional electronic tag 711 shares other portions except for the representative electronic tag and the panel 808 and 812 and has only the display function. Therefore, when the promotional electronic tag 711 is installed on the product display stand 702, it is manufactured by being associated with the representative electronic tag, such that it may be manufactured at relatively low price.

As described above, the electronic shelf label system according to the second exemplary embodiment of the present invention uses the previously installed electronic tags in order to promote the entire store or the specific products, thereby making it possible to add the promotional electronic tag by using the minimum configuration.

The exemplary embodiments of the present invention use the hybrid communication in which the wired/wireless are mixed to disperse the communication traffic between the wired/wireless converter and the electronic tags into the wired/wireless, thereby making it possible to build the more efficient and robust communication environment while suppressing the increase of the communication traffic.

Further, the exemplary embodiments of the present invention use the hybrid communication in which the wired/wireless are mixed to remove the communication shadow area between the wired/wireless converter and the electronic tags, thereby making it possible to build the more stable communication environment.

In addition, the exemplary embodiments of the present invention perform the wireless communication with the wired/wireless converter by using a portion of the electronic tags, such that the configuration of the remaining electronic tags is simplified, thereby making it possible to reduce the hardware costs.

Moreover, the exemplary embodiments of the present invention can provide the basic information such as the existing price, expiration date, production date, etc., to the electronic tag and promote products while maximally suppressing the additional costs of the electronic tags.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed Is:

1. An electronic shelf label system, comprising:
a wired/wireless converter wirelessly transmitting product information according to a request of a server;
at least one rail installed on a product display stand and including a plurality of electrical wirings;
at least one first electronic tag installed in the rail and performing wireless communication with the wired/wireless converter; and
a plurality of second electronic tags each installed in the rail and performing wired communication with the first electronic tag through the electronic wirings.

2. The electronic shelf label system according to claim 1, wherein the first electronic tag performs a communication relaying function between the wired/wireless converter and the second electronic tag.

3. The electronic shelf label system according to claim 1, wherein the first and second electronic tags includes a display unit displaying the product information.

4. The electronic shelf label system according to claim 3, wherein the display unit of the first and second electronic tags is configured of an electrophorectic display (EPD).

5. The electronic shelf label system according to claim 1, wherein the second electronic tag includes a display unit displaying the product information.

6. The electronic shelf label system according to claim 1, wherein the electrical wirings are disposed on a substrate to be inserted into the rail or installed at the outside.

7. The electronic shelf label system according to claim 6, wherein the substrate is a flexible printed circuit board.

8. The electronic shelf label system according to claim 1, further comprising a plurality of first connectors electrically connected to the electrical wirings and exposed to the outside.

9. The electronic shelf label system according to claim 8, further comprising a plurality of second connectors provided on one surface of each of the first and second electronic tags and electrically contacting the first connectors.

10. The electronic shelf label system according to claim 1, wherein at least one of the electrical wirings is electrical wirings for a power supply for supplying power to the first and second electronic tags.

11. The electronic shelf label system according to claim 1, wherein the wired/wireless converter and the first electronic tag are connected to each other in a star topology type.

12. The electronic shelf label system according to claim 1, wherein the first electronic tag and the second electronic tag are connected to each other in a star topology type.

13. A communicating method using an electronic shelf label system including a wired/wireless converter wirelessly transmitting product information according to a request of a server, at least one first electronic tag performing wireless communication with the wired/wireless converter, and a plurality of second tags performing wired communication with the first electronic tag, the communicating method comprising:
(a) collecting and storing IDs of the second electronic tags by the first electronic tag;
(b) searching the first electronic tags or the second electronic tags of specific IDs corresponding to product information received from the wired/wireless converter to request update of the product information; and
(c) transmitting a request performance response signal informing performance ending after the product information is updated.

14. The communicating method using an electronic shelf label system according to claim 13, wherein the step (a) further includes transmitting a response request signal in order for the first electronic tags to identify the second electronic tags.

15. An electronic shelf label system, comprising:
a wired/wireless converter wirelessly transmitting information according to a request of a server;
at least one rail installed on a product display stand;
at least one first electronic tag installed in the rail and performing wireless communication with the wired/wireless converter;
a plurality of second tags each installed in the rail and performing wired communication with the first electronic tag; and
at least one third electronic tag installed on the product display stand and performing wired communication with the first electronic tag.

16. The electronic shelf label system according to claim 15, wherein the first electronic tag communicating with the third electronic tag performs a master function and the third electronic tag performs a slave function of the first electronic tag or the second electronic tag.

17. The electronic shelf label system according to claim 15, wherein the third electronic tag shares circuits configuring the first electronic tag or the second electronic tag other than a panel for displaying information

18. The electronic shelf label system according to claim 15, wherein the rail includes electrical wirings electrically connecting the first electronic tags and the second electronic tags.

19. The electronic shelf label system according to claim 15, wherein the panel of the second electronic tag and the third electronic tag are manufactured to have different areas.

20. The electronic shelf label system according to claim 15, wherein the panel of the first to third electronic tags is an electrophoretic display (EPD).
